(19) United States
(12) Patent Application Publication
(10) Pub. No.: US 2025/0031626 A1
(43) Pub. Date: Jan. 30, 2025

(54) Concave transfer plate

(71) Applicant: George Kuchar, Eagerville, IL (US)

(72) Inventor: George Kuchar, Eagerville, IL (US)

(21) Appl. No.: 18/445,363

(22) Filed: Jul. 28, 2023

(51) Int. Cl. A01F 12/24

(52) U.S. Cl. CPC A01F 12/24

(57) ABSTRACT

In accordance with one aspect of the present invention, there is provided a concave which has axially extending members and circumferentially extending members. With the round axially extending, members elevated, causing the crop to roll and break apart and a concave drop plate that serves as a reservoir to allowing much more even feeding of material across the entire width of the concave. The concave transfer plate allows a more efficient and complete separation process while reducing engine horsepower requirements, thus fuel consumption.

### FIELD OF THE INVENTION

The present invention relates to transfer plate on the right side of the concave and, more particularly, to a transfer plat recessed on the right side of the concave creating a feeding pocket to even out the flow of material into the concave.

### BACKGROUND OF THE INVENTION

This invention relates to a combine in which one or more rotors or contacting concaves are mounted longitudinally of the axis of the combine. Combines of this type are relatively expensive, and especially to justify substantial investment in a combine, it is desirable that the same be capable of harvesting a relatively wide variety of crop products efficiently. Concaves employed in so-called universal type combines of the kind referred to comprise a series of bars which extend longitudinally in the threshing compartment of the combine and a series of longitudinally spaced curved rods extend transversely through said bars to provide openings through which threshed material passes and is received by a grain pan beneath the concave, said pan discharging onto a suitable sieve unit incident to completing the separation of the product material from chaff and other waste material.

Several downsides occur because of the present art forms of concaves. These faults are a slowing of the material, especially in high moisture or other less than ideal conditions such as greater leaf material, higher crop yields, and wear of the machine parts. These faults result in more grain damage, greater grain loss through the waste material ejection system on the combine, and higher fuel consumption. Downtime is often incurred by the operator in attempts to unplug the harvesting machine when extensive material flows cause the separation system to plug up, shutting down all harvesting processes until the situation can be remedied.

Not only is the economy adversely effected from a quantitative and qualitative point, but fuel consumption is increased; possible damage from deteriorating weather conditions is increased as is the safety of the operator engaged in the unplugging of the machine.

The advent of pharmaceutical harvesting of grains has increased the need for gentle harvesting techniques. Pharmaceutical harvesting refers to the growing of crops for the removal of particular germs, cells, or components for use in the pharmaceutical industry. However, such harvested grain is held to higher standards of quality control than food or feed grains are held to, thus upping the requirement for less damage to the kernel during harvesting.

Equipment manufacturers have sought to solve this issue since the first combine was manufactured and have used a variety of means to deal with the issue. One solution is to reverse the direction trough the feeding mechanism, pulling the plugged material back from the direction it came in.

Another solution attempt is made by increasing the rotational speed of the rotor to force the material through the separation unit. Twin rotors are yet another example in known art of a method to process large amounts of material through the separation system without increasing loss or damage to the grain.

Neihaus, U.S. Pat. No. 4,499,908, developed an inwardly interior flat-surfaced concave to eliminate the catching of crop materials.

Rowland-Hill, U.S. Pat. No. 4,031,901 provides for rotatable sleeves that rotate over the arcuate rods of the concave in an attempt to facilitate the passage of threshed crop material through the openings in the concave to reduce crop damage.

Other U.S. patents by Rowland-Hill relating to combine harvesters include U.S. Pat. Nos. 3,742,686, 3,696,815, and 3,631,862.

Kuchar, U.S. Pat. No. 4,909,7 provides for more bars in the concave to permit a reduced rotational speed of the cylinder, thus reducing crop damage in the separation mechanism.

Peiler, U.S. Pat. No. 4,3,000, received a patent for the ability to have adjusting linkage enabling the operator to change the distance relationship between the concave and the cylinder.

Williams, U.S. Pat. No. 4,284,086 attempted to clean the cylinder concave area with air pressure to reduce clogging and build-up of material.

Glaser, U.S. Pat. No. 4,258,6 used vanes to direct the crop into various portions of the separation mechanism to reduce clogging and damage.

Johnston, U.S. Pat. No. 4,222,395 used protruding fingers that were either mechanically adjusted or remotely adjusted to control the flow rate through the separation mechanism.

Ausherman, U.S. Pat. No. 3,927,679 used an elevated sharpened raspbar fin to “cut” through the crop material, forcing it through the separation mechanism.

Knap, U.S. Pat. No. 3,568,682 describes a grate to be placed under the separation mechanism that crop material passes over.

Gerhardt, U.S. Pat. No. 3,552,396, uses a hydraulic cylinder to adjust the concave spacing relationship with the cylinder.

Johnson, U.S. Pat. No. 2,457,680, used an inwardly zigzag configuration on his concave design to provide for a more efficient means of threshing grain.

Plugged material removal from a reversal of the direction of the mechanical components that created the plug doesn't always work, and when they don't can damage parts of the machine, increasing downtime and repair costs. They also do not then properly process the crop in a manner that provides a quantitative or qualitative product.

To prevent foreign material from clogging the concave, some combine manufacturers have increased the rotational velocity of the cylinder to force the foreign material through the apertures in the forward portion of the concave and to maintain these apertures open. However, increasing the rotational velocity of the cylinder increases the likelihood of damage to the harvested crop. This damage is caused by increased impact forces as the faster cylinder contacts the separated grain and appears as cracking, making the grain more susceptible to infestation and deterioration.

Increasing the rotational velocity of the cylinder also causes more of the crop residue, which is displaced along the concave, to be recirculated by the cylinder rather than being discharged from the aft, upper edge of the concave. Back feeding of the crop residue, or its recirculation about the rotating cylinder, reduces the combine's capacity to separate the grain from the plant residue resulting in reduced recovered yields and the higher likelihood of residue clogging of the concave.

Finally, operating the cylinder at increased rotational velocities increases the combine's fuel consumption rate and is thus less fuel-efficient. Forcing material through the separation unit of the machine only increased the damage done to the grain portion of the crop resulting in a lower or no value product such as for pharmaceutical harvesting where the grain must be held to a much higher quality than food quality grains are held.

Twin rotors increase the cost of manufacturing substantial as well as the cost of maintenance in parts and labor; now, the operator has two separation systems to be concerned with and to clean and maintain.

Changing the distance relationship between the cylinder and the concave does not reduce damage. Decreasing the distance creates a plugging effect and increasing the distance results in un-thrashed crop material passing through the separation mechanism.

Smooth surfaces further defeat the purpose by eliminating much of the frictional area that the concave proposes to provide as a means of removing the seed heads or grain from the stocks or leafy material.

It would be desirable to decrease damage caused to crops as the result of separation and thrashing.

It would also be desirable to reduce operating expenses by reducing fuel consumption.

It would also be desirable to reduce operator maintenance and downtime from machine damage by reducing plugged and damaged separation units.

It would also be desirable to reduce downtime from plugged separation units.

It would also be desirable to increase the price of the crop harvested through a reduction in damage.

It would also be desirable to provide faster, more economical harvesting.

It would also be desirable to reduce weather damaged crops by increasing the speed and reliability of the harvest.

### SUMMARY OF THE INVENTION

In accordance with one aspect of the present invention, there is provided a concave which has axially extending members and circumferentially extending members. With the round axially extending, members elevated, causing the crop to roll and break apart and a concave transfer plate that serves as a reservoir to allowing much more even feeding of material across the entire width of the concave. The concave transfer plate allows a more efficient and complete separation process while reducing engine horsepower requirements thus fuel consumption.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an inside perspective view of a concave showing the relationship between the bars and the transfer plate.

For purposes of clarity and brevity, like elements and components will bear the same designations and numbering throughout the FIGURES.

### DESCRIPTION OF THE PREFERRED EMBODIMENT

### Brief Description of the Drawings

A complete understanding of the present invention may be obtained by reference to the accompanying drawings, when considered in conjunction with the subsequent, detailed description, in which:

### DESCRIPTION OF THE PREFERRED EMBODIMENT

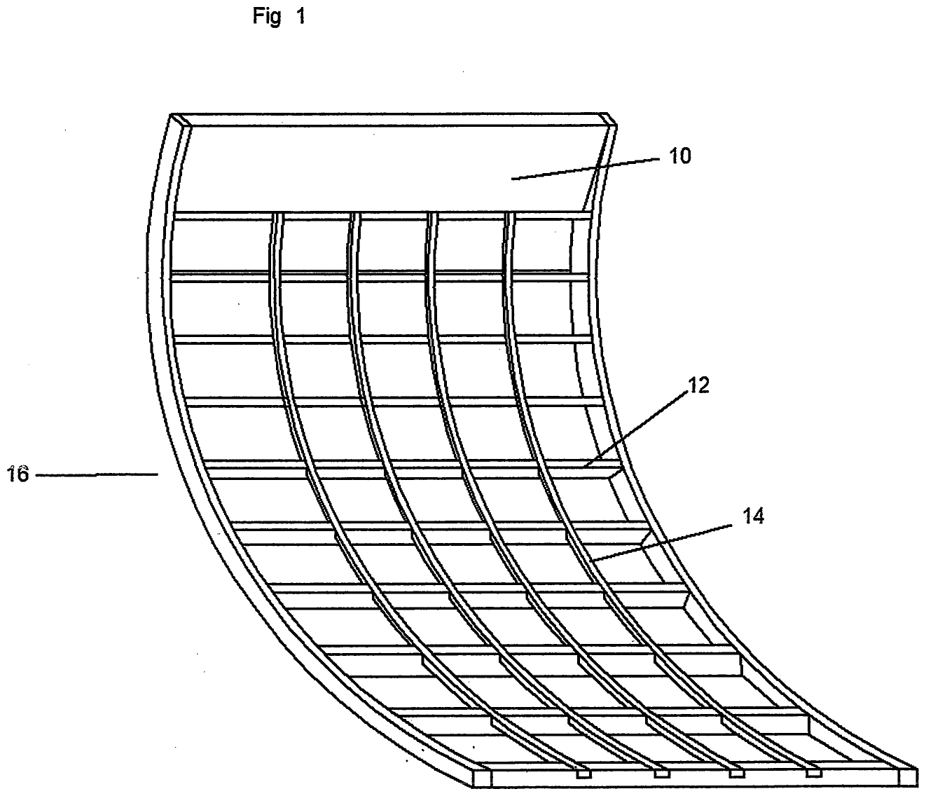

FIG. 1 is a side cross-section view of a concave 16.

### DESCRIPTION OF THE PREFERRED EMBODIMENT

Referring to FIG. 1. A side cross-section view of a concave 16 in accordance with the principles of the present invention. The purpose of the invention is to enable a more thorough, faster, and gentler separation of grain from its cob, head, or pod. In a modern combine harvester, the grain is collected through the front of the harvester and then processed through the machine. Various forms of separation occur throughout this process; however, the principal form takes place in between the rotor and the concave 16. The rotor spins and has raspbars which press the grain against the concave 16. The distance between the rotor raspbars and the concave 16 is adjustable for different size grains and different harvest conditions. The combine harvester operator needs to adjust this distance to meet the varying needs, sometimes multiple times a day. By raising the arcuate rods 14 above the crossbars 12, the adjustment range is magnified, meaning the operator can harvest for more extended periods without adjusting and still obtain a high harvest rate without increased damage or loss to the grain crop being harvested. Thus, the purpose of this invention is to make harvest faster, easier, more efficient with less grain loss, and higher quality by lowering damage caused by the incorrect rotor to concave 16 adjustments by creating a recessed pocket by means of a transfer plate 10 located on the right side of the concave 16.

In various suitable embodiments, the transfer plate 10 having a range of widths from greater than 2 inches to about 6 inches and a length equal to that of the inside width of the concave 16, and recessed from about 4 inch to about % inch. The transfer plate 10, is preferably made of a rigid, durable material such as steel, although other materials would also work.

A complete understanding of the present invention may be obtained by reference to the accompanying drawings, when considered in conjunction with the subsequent, detailed description, in which:

There has thus been shown an improved concave 16 arrangement for use in a combine for separating the grain bearing and leafy portions of a plant. The transfer plate 10 in the concave's crop engaging member permits the even flow of material which reduces impact damage of the grain by the moving raspbars allows the cylinder to rotate more slowly with increased grain recovery and improved fuel efficiency. While particularly preferred embodiments of the present invention have been shown and described, it will be evident to those skilled in the art that changes and modifications may be made without departing from the invention in its broader aspects. Therefore, the aim in the claims is to cover all such changes and modifications as fall within the scope of the invention. The matter set forth in the foregoing description and accompanying drawings is offered by way of illustration only and not as a limitation.

Since other modifications and changes varied to fit particular operating requirements and environments will be apparent to those skilled in the art, the invention is not considered limited to the example chosen for purposes of disclosure and covers all changes and modifications which do not constitute departures from the scope of this invention. Having thus described the invention, what is desired to be protected by Letters Patent is presented in the claims.

Having thus described the invention, what is desired to be protected by Letters Patent is presented in the subsequently appended claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A concave transfer plate for spreading out and evening of material flow through the concave for the purpose of increasing harvest speed, quality and reducing energy requirements, comprising:
means for creating a reservoir for excess crop material to even the flow through the thrashing system.

2. The concave transfer plate in accordance with claim 1, wherein said means for creating a reservoir for excess crop material to even the flow through the thrashing system comprises a recessed, structurally sound material, flat, 2″ or greater minimum width, 6″ or less maximum width transfer plate.

3. A concave transfer plate for spreading out and evening of material flow through the concave for the purpose of increasing harvest speed, quality and reducing energy requirements, comprising:
a recessed, structurally sound material, flat, 2″ or greater minimum width, 6″ or less maximum width transfer plate, for creating a reservoir for excess crop material to even the flow through the thrashing system.

4. A concave transfer plate for spreading out and evening of material flow through the concave for the purpose of increasing harvest speed, quality and reducing energy requirements, comprising:
a recessed, structurally sound material, flat, 2″ or greater minimum width, 6″ or less maximum width transfer plate, for creating a reservoir for excess crop material to even the flow through the thrashing system.
